(19) United States
(12) Patent Application Publication
(10) Pub. No.: US 2026/0227074 A1
(43) Pub. Date: Aug. 6, 2026

(54) DOOR LATCH DEVICE AND COOKING APPARATUS HAVING SAME

(71) Applicant: SAMSUNG ELECTRONICS CO., LTD., Suwon-si (KR)

(72) Inventors: Sooncheol KWEON, Suwon-si (KR); Sangwon YUN, Suwon-si (KR); Bokhyun JANG, Suwon-si (KR)

(73) Assignee: SAMSUNG ELECTRONICS CO., LTD., Suwon-si (KR)

(21) Appl. No.: 19/636,523

(22) Filed: Apr. 1, 2026

Related U.S. Application Data
(63) Continuation of application No. PCT/KR2024/010102, filed on Jul. 15, 2024.

(30) Foreign Application Priority Data
Oct. 12, 2023 (KR) 10-2023-0136038

(51) Int. Cl. F24C 15/02; E05B 47/00

(52) U.S. Cl. CPC F24C 15/022; E05B 47/0012; E05B 2047/0017; E05B 2047/002; E05B 2047/0068

(57) ABSTRACT

A cooking apparatus includes a housing including a cooking chamber; a door to open or close the cooking chamber and including a key door; a driver motor disposed in the housing; and a door latch to lock or unlock the door. The door latch includes a rotating body which can be rotated by power transmitted from the driver motor, a lever shaft, a lever configured to be rotated about the lever rotation axis by power transmitted from the rotating body, the lever configured to restrain the key door to lock the door or release the key door to unlock the door according to the position of the lever, and an elastic member which is to elastically press the lever and rotates the lever in a direction in which the lever locks or unlocks the door by engaging with the key door according to the position of the lever.

### CROSS REFERENCE TO THE RELATED APPLICATION

This application is a continuation application, filed under 35 U.S.C. § 111(a), of International Application PCT/KR2024/010102 filed on Jul. 15, 2024 and is based on and claims priority under 35 U.S.C. § 119 to Korean Patent Applications No. 10-2023-0136038, filed on Oct. 12, 2023, in the Korean Intellectual Property Office, the disclosures of which are incorporated by reference herein in their entireties.

### TECHNICAL FIELD

The present disclosure relates to a door latch device and a cooking apparatus including the same.

### BACKGROUND ART

In general, a cooking apparatus is a device for heating and cooking an object to be cooked, such as food. Particularly, the cooking apparatus may perform various functions related to cooking, such as heating, thawing, drying, and sterilizing the object to be cooked. Examples of such cooking apparatuses include ovens, such as gas ovens or electric ovens, microwave ovens (hereinafter referred to as microwave), gas ranges, electric ranges, microwave ovens with hoods (Over The Range (OTR)), gas grills, or electric grills.

In general, an oven is a device that cooks food by directly transferring heat to the food or heating an inside of a cooking chamber through a heat source that generates heat, such as a heater. A microwave is a device that cooks food by using frictional heat between molecules that is generated by disrupting a molecular arrangement of the food with a high frequency as a heat source.

The cooking apparatus may include a cooking chamber for cooking food and a door configured to open and close the cooking chamber.

The cooking apparatus may include a door latch configured to detect opening and closing of the door or configured to open and close the door. Various components may be used as the door latch. Depending on a direction, in which the door is opened and closed, and the type of cooking apparatus, the door latch may require a different arrangement or structure.

### DISCLOSURE

### Technical Problem

The present disclosure is directed to providing a cooking apparatus including a door opening device configured to be opened automatically.

Further, the present disclosure is directed to providing a cooking apparatus including a door latch configured to be opened and closed without interference with other components.

Additional aspects of the disclosure will be set forth in part in the description which follows and, in part, will be obvious from the description, or may be learned by practice of the disclosure.

### Technical Solution

One aspect of the present disclosure provides a cooking apparatus including: a housing forming a cooking chamber; a door configured to open and close the cooking chamber and including a key door protruding toward the housing; a driving motor disposed within the housing; and a door latch configured to lock or unlock the door. The door latch includes: a rotating body configured to be rotated by power transmitted from the driving motor; a lever configured to be rotated about a lever rotation shaft by power transmitted from the rotating body, the lever configured to restrain or release the key door according to a position of the lever; and an elastic member configured to elastically press the lever and configured to rotate the lever in a direction in which the lever locks or unlocks the door according to the position of the lever.

Another aspect of the present disclosure provides a door latch device configured to lock or unlock a door including a key door, the door latch device including: a driving motor; and a door latch configured to lock or unlock the door. The door latch includes: a rotating body configured to be rotated by power transmitted from the driving motor; a lever configured to be rotated about a lever rotation shaft by power transmitted from the rotating body, the lever configured to restrain or release the key door according to a position of the lever; and an elastic member configured to elastically press a latch housing, to which the lever is coupled, and the lever and configured to rotate the lever to a first position, in which the door is locked, or a second position, in which the door is unlocked, according to a position of the lever.

A cooking apparatus includes a housing including a cooking chamber; a door configured to open or close the cooking chamber, the door comprising a key door; a driving motor disposed in the housing; and a door latch configured to lock or unlock the door, wherein the door latch comprises: a rotating body configured to be rotated by power transmitted from the driving motor; a lever rotation shaft; a lever configured to be rotated about the lever rotation shaft by power transmitted from the rotating body, the lever configured to restrain the key door to lock the door or release the key door to unlock the door according to a position of the lever; and an elastic member configured to elastically press the lever and configured to rotate the lever in a direction in which the lever locks or unlocks the door by engaging with the key door according to the position of the lever.

The lever is configured to be rotated between a first position that restrains the key door in response to the door being closed and a second position that releases the key door to allow the door to be opened, wherein the elastic member has a maximum elastic force at a critical position of the lever between the first position and the second position of the lever.

The lever is elastically pressed in a locking direction of the door by the elastic member between the first position and the critical position, and the lever is elastically pressed in an unlocking direction of the door by the elastic member between the second position and the critical position.

The lever comprises a lever arm extending from the lever rotation shaft and configured to receive power from the rotating body.

The key door comprises a key door hole formed on an end portion of the key door, wherein the lever further comprises: a lever groove to accommodate an end portion of the key door; and a lever hook to be accommodated in the key door hole in response to the end portion of the key door being accommodated in the lever groove.

While the door is being opened, the lever is configured to rotate past the critical position to the second position and is separated from the key door hole; and while the door is being closed, the lever is configured to rotate past the critical position to the first position and is accommodated in the key door hole.

The door latch further comprises a driving protrusion protruding from one surface of the rotating body.

The driving protrusion comprises a plurality of driving protrusions arranged at intervals along a circumferential direction of the rotating body, and wherein an angle between a pair of adjacent driving protrusions among the plurality of driving protrusions is greater than or equal to an angle at which the driving protrusion in contact with the lever at the first position is rotated to the critical position.

The driving protrusion comprises a pressure protrusion protruding toward a tangential direction of the rotating body, wherein the lever arm includes a lever access to accommodate at least a portion of the driving protrusion therein.

The door latch comprises a sensor to determine whether the door is opened or closed.

The door latch further comprises a latch housing to which the lever is coupled, wherein one end of the elastic member is fixed to the latch housing and an other end of the elastic member is fixed to the lever.

The door latch is a first door latch, the rotating body is a first rotating body, the elastic member is a first elastic member, the key door is a first key door, and the lever is a first lever, wherein the door further comprises a second key door, wherein the housing further comprises a second door latch configured to lock or unlock the door, wherein the second door latch comprises: a second rotating body connected to the first rotating body via a link rod; a second lever configured to be rotated by power transmitted from the second rotating body, the lever configured to restrain the second key door to lock the door or release the second key door to unlock the door according to a position of the second lever; and a second elastic member configured to elastically press the second lever according to a rotation of the second lever, the second elastic member configured to rotate the second lever in a direction in which the second lever locks or unlocks the door by engaging with the second key door according to the position of the second lever.

The lever groove is a first lever groove, wherein the second key door comprises a second key door hole formed on an end portion of the second key door, wherein the second lever comprises: a second lever arm extending from the lever rotation shaft and configured to receive power from the second rotating body; a second lever groove to accommodate an end portion of the second key door; and a second lever hook to be accommodated in the second key door hole in response to the end portion of the second key door being accommodated in the second lever groove.

The sensor includes at least one micro switch.

### Advantageous Effects

A user can automatically open a door without directly pulling the door because a driving motor operates in response to a door opening signal that is input by the user, and a door latch opens the door by power transmitted from the driving motor.

Additional aspects of the disclosure will be set forth in part in the description which follows and, in part, will be obvious from the description, or may be learned by practice of the disclosure.

### DESCRIPTION OF DRAWINGS

FIG. 1 is a perspective view of a cooking apparatus according to one embodiment of the present disclosure.

FIG. 2 is a view illustrating a state in which a door is opened in the cooking apparatus illustrated in FIG. 1.

FIG. 3 is a cross-sectional view of FIG. 1 taken along a plane parallel to the door from an inside of the door.

FIG. 4 is an exploded view of some components of the cooking apparatus illustrated in FIG. 1.

FIG. 5 is a perspective view illustrating a door latch of the cooking apparatus according to one embodiment of the present disclosure.

FIG. 6 is a side view of the door latch of the cooking apparatus according to one embodiment of the present disclosure.

FIG. 7 is a side view of the door latch of the cooking apparatus according to one embodiment of the present disclosure.

FIG. 8 is a side view of the door latch of the cooking apparatus according to one embodiment of the present disclosure.

FIG. 9 is a side view of the door latch of FIG. 6 when viewed from the opposite side.

FIG. 10 is a perspective view illustrating a door latch of the cooking apparatus according to one embodiment of the present disclosure.

FIG. 11 is an exploded perspective view of a door latch according to one embodiment of the present disclosure.

FIG. 12 is an exploded perspective view of the door latch of FIG. 11 when viewed from another side.

FIG. 13 is a view illustrating a state in which an external force is applied while opening the door of the cooking apparatus according to one embodiment of the present disclosure.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Meanwhile, the terms “upper and lower directions,” “lower side,” and “front and rear directions” used in the following description are defined based on the drawings, and the shape and position of each component are not limited by these terms.

Hereinafter exemplary embodiments of the present disclosure will be described in detail with reference to the accompanying drawings.

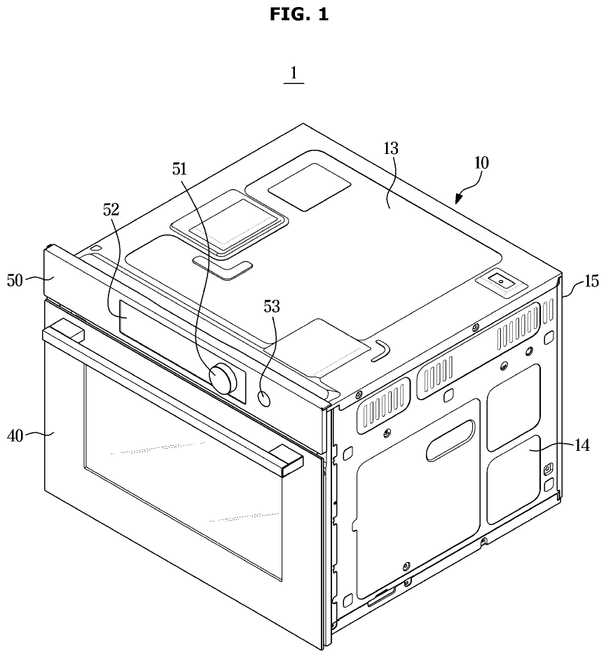

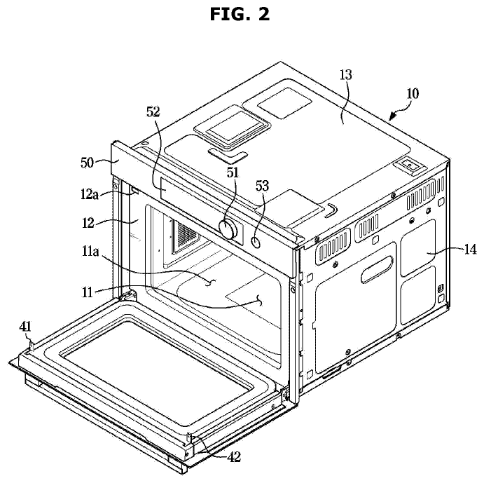

FIG. 1 is a perspective view of a cooking apparatus 1 according to one embodiment of the present disclosure, and FIG. 2 is a view illustrating a state in which a door 40 is opened in the cooking apparatus 1 illustrated in FIG. 1.

The cooking apparatus 1 is a device for heating and cooking an object to be cooked, such as food, and may provide various functions related to cooking, such as heating, thawing, drying, and sterilizing the object to be cooked. The cooking apparatus 1 may include ovens, such as gas ovens or electric ovens, microwave ovens (hereinafter referred to as microwave), gas ranges, electric ranges, microwave ovens with hoods (Over The Range (OTR)), gas grills, or electric grills. The cooking apparatus 1 may include a heater, hot air, or a magnetron as a heat source.

The cooking apparatus 1 may be installed on a wall or inside a storage cabinet to create a sense of integration with a kitchen space. That is, the cooking apparatus 1 may be a built-in type.

The cooking apparatus 1 may include a housing 10 forming a basic structure of the cooking apparatus 1. Particularly, the housing 10 may include an outer housing 10a forming an exterior of the cooking apparatus 1, and an inner housing 10b disposed inside the outer housing 10a and forming a cooking chamber 11.

The cooking chamber 11, in which food to be cooked is inserted and the food is cooked, may be provided in the housing 10. A portion of the cooking chamber 11 may be open to allow food to be inserted thereinto. The housing 10 may include a cooking chamber opening 11a to allow food to be inserted and to be withdrawn through the open portion of the cooking chamber 11. The cooking chamber opening 11a may be formed on a front surface of the housing 10.

The outer housing 10a may include an upper panel 13, a side panel 14, a rear panel 15, and a lower panel 16 forming an outer surface of the cooking apparatus 1. The upper panel 13, the side panel 14, the rear panel 15, and the lower panel 16 may each be formed to include a flat plate shape. However, the present disclosure is not limited thereto.

The upper panel 13 may be disposed on an upper portion of the housing 10 to form an upper surface of the cooking apparatus 1.

A plurality of side panels 14 may be provided. For example, the side panel 14 may be provided in pairs, and a pair of side panels 14 may be respectively arranged on the left and right sides of the housing 10 to form left and right surfaces of the cooking apparatus 1.

The rear panel 15 may be disposed at a rear portion of the housing 10 to form a rear surface of the cooking apparatus 1.

The housing 10 may include a front frame 12 arranged on a front side of the housing 10. The front frame 12 may be formed in a frame shape that includes the cooking chamber opening 11a while covering at least a portion of the front surface of the housing 10. The front frame 12 may be provided along a perimeter of the cooking chamber opening 11a. A front surface of the front frame 12 may be covered by the door 40 when the door 40 is closed.

A front surface of the cooking apparatus 1 may be formed by the door 40 and a controller 50 coupled to the front side of the housing 10.

The door 40 may be configured to open and close the cooking chamber 11. The door 40 may be coupled to the housing 10 so as to be rotatable relative to the housing 10.

The door 40 may be coupled to the housing 10 by door hinges provided at lower ends on opposite sides of the front of the housing 10. The door 40 may be configured to be rotated around a rotation axis extending left and right from a lower end of the housing 10.

The door 40 may be configured to be manually closed by a force applied by a user to press the door 40 toward the housing 10. The door 40 may be configured to be automatically opened by a manipulator 51 or a door opening button 53 of the controller 50.

A portion of the door 40 may be transparent to allow a user to see an inside of the cooking chamber 11 when the door 40 is closed. The transparent portion of the door 40 may include a heat-resistant glass material so as not to be damaged by the heat inside the cooking chamber 11. However, the present disclosure is not limited thereto.

The door 40 may include a key door 41 protruding from a rear surface of the door 40 toward the housing 10. While the key door 41 interacts with a door latch 100 to be described later, the key door 41 may allow the door latch 100 to detect the opening and closing of the door 40. To this end, the key door 41 may include a key door hole 41a provided at an end portion of the key door 41. For the stable opening and closing of the door 40, the key door 41 may be provided at left and right end portions of the door 40. However, the present disclosure is not limited thereto.

The cooking apparatus 1 according to one embodiment of the present disclosure may include a handle protruding from one surface of the door 40 to allow a user to easily open and close the door 40. However, the handle is not necessarily required. In other words, the handle may not be provided to ensure aesthetic appeal, space utilization, and a simple appearance of the cooking apparatus 1.

The controller 50 may include the manipulator 51 configured to allow the cooking apparatus 1 to perform a function, a display 52 configured to transmit a status of the cooking apparatus 1, such as a temperature inside the cooking chamber 11, to a user, and the door opening button 53 configured to open the door 40. The door opening button 53 is not necessarily formed in the form of a button as illustrated, and various methods such as a switch or lever may be utilized. In addition, even when a separate door opening button 53 is not provided, the manipulator 51 may have a function of opening the door 40.

That is, although it is illustrated that the display 52 is provided separately, the manipulator 51 is provided as a dial, and the door opening button 53 is provided as a pressure button, the present disclosure is not limited thereto. For example, components of the controller 50 may be provided in the form of a touch display 52 rather than a physical button or dial.

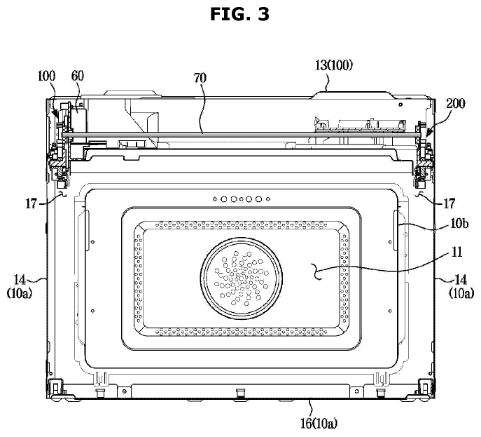

FIG. 3 is a cross-sectional view of FIG. 1 taken along a plane parallel to the door 40 from an inside of the door 40.

As illustrated in FIG. 3, the cooking apparatus 1 may include a predetermined separation space 17 between the outer housing 10a and the inner housing 10b. The door latch 100 may be provided in the separation space 17.

The door latch 100 detects the opening and closing of the door 40, and only one door latch may be provided in the cooking apparatus 1. However, when only one door latch 100 is provided, difficulties such as twisting of the door 40 when opening and closing may occur. In this case, the door 40 may not be closed properly, and high-frequency waves or heat inside the cooking apparatus 1 may be released to the outside. Therefore, it is appropriate that two or more door latches 100 are provided. However, the present disclosure is not limited thereto.

FIG. 3 illustrates that a first door latch 100 and a second door latch 200 are arranged on the left and right and are disposed in the separation space 17, but the number and arrangement of the door latches 100 are not limited thereto.

For convenience of description, the following description will be based on one door latch 100 positioned in the separation space 17. When two or more door latches 100 are provided, not all door latches 100 must have the same component, and some components may be omitted.

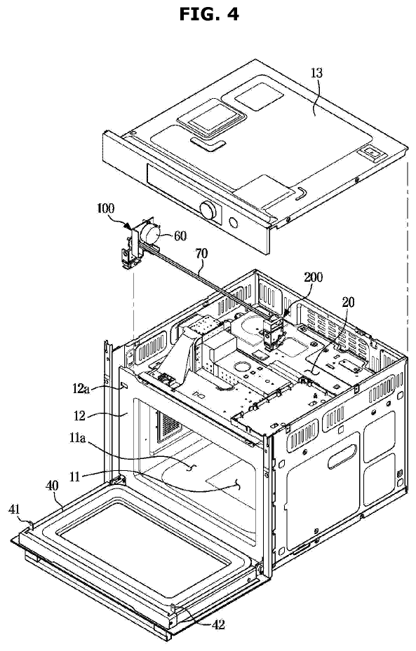

FIG. 4 is an exploded view of some components of the cooking apparatus 1 illustrated in FIG. 1.

Referring to FIG. 4, the cooking apparatus 1 may include the door 40, the outer housing 10a, the inner housing 10b, the door latch 100, and an electrical compartment 20 provided above the cooking chamber 11 as well as other electrical components. The electrical compartment 20 may be formed as a space partitioned from the cooking chamber 11 by a plate.

The front frame 12 of the cooking apparatus 1 may include a through-hole 12a through which the key door 41 may be inserted.

In order to open and close the door 40, the first door latch 100 and the second door latch 200, which are connected through a link rod 70 having a substantially bar shape, may interact with a first key door 41 and a second key door 42 which protrude from one surface of the door 40, respectively.

However, it is not necessary that the first door latch 100 and the second door latch 200 be connected through the link rod 70.

The electrical compartment 20 may accommodate various electrical components, including a circuit board for controlling the cooking apparatus 1, and may include wires for supplying power to the electrical components.

The cooking apparatus 1 according to one embodiment of the present disclosure may include the door latch 100. The door latch 100 may be configured to open the door 40 in a closed state or maintain the door 40 in the closed state.

In addition, the cooking apparatus 1 may include a driving motor 60 configured to be rotated according to an opening signal transmitted by a user through the controller 50. The door latch 100 may be configured to receive power from the driving motor 60 to open the door 40. That is, the door latch 100 may be configured to automatically open the door 40 of the cooking apparatus 1.

In other words, the door 40 may be automatically opened via the door latch 100 without a user having to apply a direct force to the door 40. Accordingly, because the user does not have to directly pull the door 40, the cooking apparatus 1 according to one embodiment of the present disclosure may not include a handle. The absence of the handle may improve aesthetics and space utilization. However, the present disclosure is not necessarily limited thereto. In other words, the handle may be included.

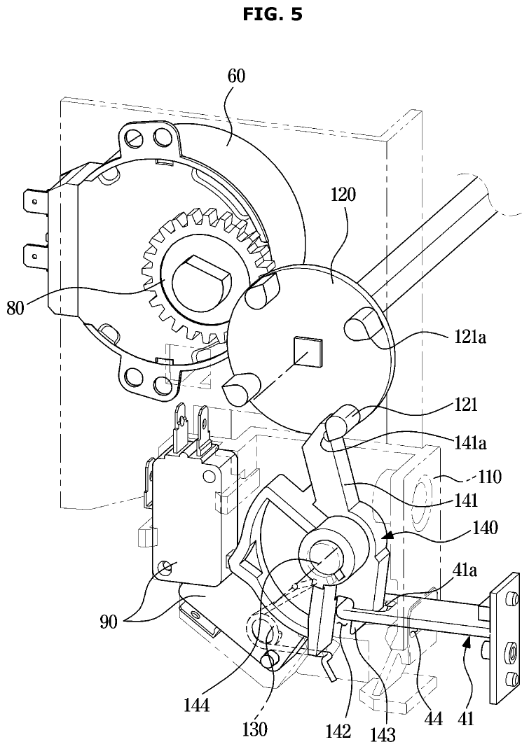

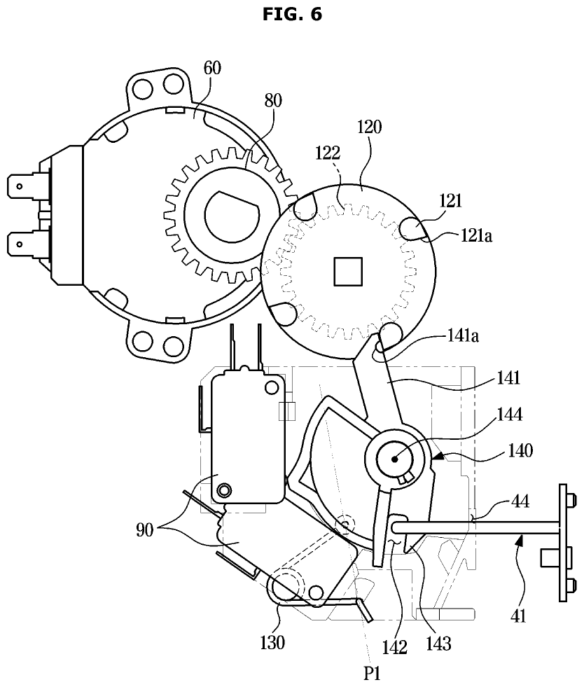

FIG. 5 is a perspective view illustrating the door latch 100 of the cooking apparatus 1 according to one embodiment of the present disclosure, and FIG. 6 is a side view of the door latch 100 of the cooking apparatus 1 according to one embodiment of the present disclosure.

The door latch 100 may include a latch housing 110 to which other components of the door latch 100 may be coupled and which forms an exterior thereof. The latch housing 110 may allow the door latch 100 to be fixed to other components, such as the housing 10, within the cooking apparatus 1, and may also serve to protect other components.

The latch housing 110 may include an opening 44 formed on the front surface into which the key door 41 may be inserted. The key door 41 may be inserted into the door latch 100 through the opening 44. Accordingly, the opening 44 is formed at a position in which the key door 41 may be inserted into the door latch 100 when the door 40 is closed.

The door latch 100 may include a rotating body 120 configured to be rotated about a transmission shaft by power transmitted from the driving motor 60 configured to operate in response to a door opening signal that is input from a user. The driving motor 60 may directly transmit power to the rotating body 120 or may transmit power via a power transmission portion 80 including at least one motor gear.

One surface of the rotating body 120 may include a rotating gear 122 for receiving power from the driving motor 60. However, it is not necessary to include a separate rotating gear 122 extending from one surface of the rotating body 120, and the rotating body 120 itself may be formed as a gear having teeth.

The door latch 100 may include a driving protrusion 121 protruding from one surface of the rotating body 120. The driving protrusion 121 may serve to efficiently transmit power, which is transmitted from the driving motor 60, to a lever 140. The driving protrusion 121 may be formed in a substantially cylindrical shape protruding from one surface of the rotating body 120.

The driving protrusion 121 may include a pressure protrusion 121a that further protrudes in a tangential direction of the rotating body 120 to efficiently rotate the lever 140. In other words, a cross-section of the driving protrusion 121 may be approximately a teardrop shape that is slightly deformed from a circle.

A single driving protrusion 121 may be provided, but a plurality of driving protrusions may be provided to increase an opening speed of the door 40 after a user inputs the door opening signal.

The door latch 100 may include the lever 140 coupled to the latch housing 110 so as to be rotatable about a latch rotation shaft. When the key door 41 is inserted into the inside of the door latch 100 through the through-hole 12a (see FIG. 2), the lever 140 may be rotated to open (unlock) or close (lock) the door 40.

Additionally, the door latch 100 may include an elastic member 130 configured to elastically press the lever 140. Particularly, the elastic member 130 may be installed in such a way that one end thereof is fixed to the latch housing 110 and the other end thereof is fixed to the lever 140. The elastic member 130 may be a coil spring or a torsion spring.

The elastic member 130 may apply a force in the direction of rotation when the lever 140 is rotated by a predetermined angle or more according to the rotation of the lever 140.

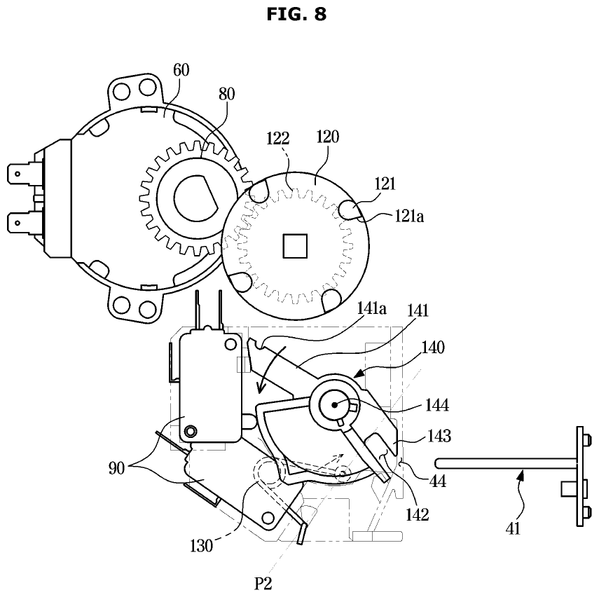

Among positions in which the lever 140 is stopped, a position when the door 40 is closed may be referred to as a first position P1 of the lever 140 (see FIG. 6), and a position when the door 40 is opened may be referred to as a second position P2 of the lever 140 (See FIG. 8). The elastic member 130 may have suitable physical properties to allow the first position P1 and the second position P2 to be formed at appropriate positions.

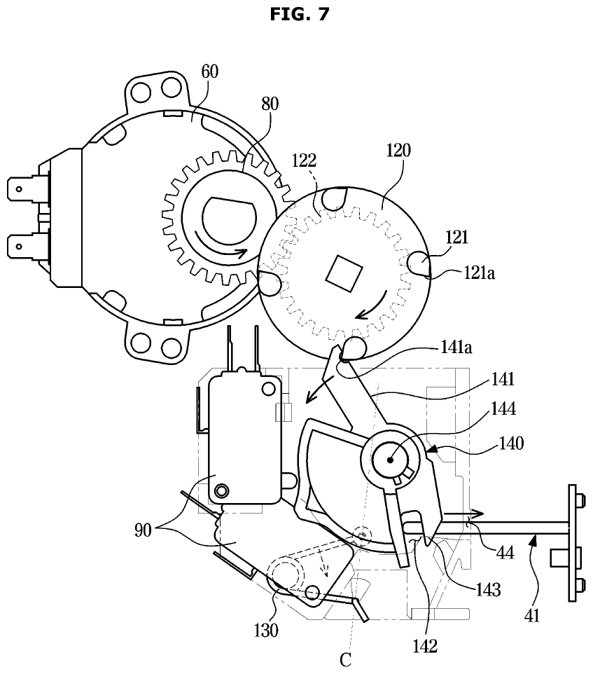

Particularly, a point in which an elastic force of the elastic member 130 is maximized when the lever 140 is rotated between the first position P1 and the second position P2 may be referred to as a critical position C of the lever 140 (See FIG. 7). At the critical position C, the elastic force may act from one end of the elastic member 130 toward a center of a lever rotation shaft 144. The fact that the elastic force is at maximum may not mean that the elastic member 130 is compressed to an elastic limit, but may mean that the elastic force of the elastic member 130 at the first position P1 and the second position P2 is maximized at the critical position C.

FIG. 6 is a view illustrating a first position state in which the door 40 is closed and the lever 140 restrains the key door 41, FIG. 7 is a view illustrating a critical position C state in which the elastic force of the elastic member 130 is maximized, and FIG. 8 is a view illustrating a second position P2 state in which the lever 140 releases the key door 41 as the door 40 is opened.

The lever 140 of the door latch 100 may include a lever arm 141 extending from the lever rotation shaft 144. Particularly, the lever arm 141 may extend from the lever rotation shaft 144 approximately toward the rotating body 120.

The lever arm 141 may be rotated between a predetermined angle (between the first position P1 and the second position P2). The driving protrusion 121 may be in contact with the lever arm 141 to transmit a force to the lever 140 from the first position P1 until the driving protrusion 121 and the lever arm 141 are separated, by passing through the critical position C.

An end portion of the lever arm 141 may include a lever recess 141a having a recessed shape on one surface of the lever arm 141. The lever recess 141a may be provided to accommodate a portion of the driving protrusion 121 and may serve to assist in the rotation of the lever 140. Particularly, the lever recess 141a may guide the pressure protrusion 121a of the driving protrusion 121 to assist in the rotation of the lever 140.

The lever 140 may include a lever hook 143 extending from the lever rotation shaft 144. The lever hook 143 may serve to assist in coupling with the key door 41. Particularly, the lever hook 143 may be inserted into the key door hole 41a provided at an end portion of the key door 41. In addition, a lever groove 142, into which the end portion of the key door 41 may be inserted, may be formed between the lever hook 143 and a portion of the lever 140.

As the key door 41 approaches the door latch 100 through the through-hole 12a, the end portion of the key door 41 may be accommodated in the lever groove 142, while the lever hook 143 is inserted into the key door hole 41a and restrains the key door 41, thereby rotating the lever 140 to the second position P2.

Conversely, when the rotating body 120 or the driving protrusion 121 rotates the lever 140 according to the operation of the driving motor 60, the lever 140 may be rotated to the first position P1 while releasing the key door 41.

When the lever hook 143 is inserted into the key door 41 and the end portion of the key door 41 is inserted into the lever groove 142, the lever 140 may be rotated stably.

A sensor 90 may be coupled to the latch housing 110 of the door latch 100. Various sensors may be coupled, but the sensor 90 configured to detect whether the door 40 is opened or closed may be coupled. Particularly, the key door 41 may be inserted toward the door latch 100, and the lever 140 may be rotated by the inserted key door 41. Due to the rotation of the lever 140, the sensor 90 may interact with a protrusion provided on one surface of the lever 140 to operate the sensor 90, thereby detecting whether

the door 40 is opened or closed.

A micro-switch may be used as the sensor 90 configured to detect whether the door 40 is opened or closed. A single sensor 90 may be provided, but a plurality of sensors 90 may be provided to prevent malfunction of the sensor 90. In other words, when the single sensor 90 is provided, the sensor 90 may be operated by a user's arbitrary manipulation.

Accordingly, as the door 40 is opened, high-frequency waves may leak out and thus it is required to prevent the leakage. Therefore, it is appropriate to include the plurality of sensors 90, and when two door latches 100 are provided, sensors 90 may be included on opposite sides.

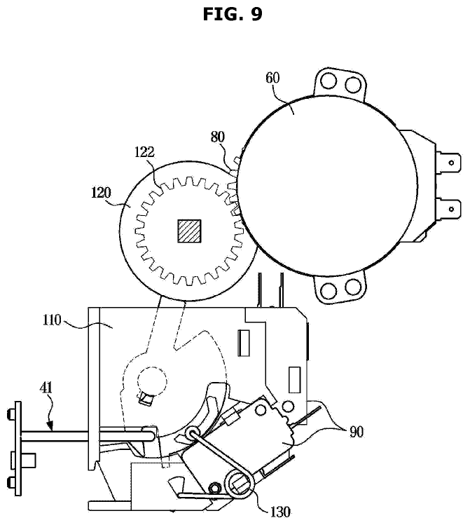

FIG. 9 is a side view of the door latch 100 of FIG. 6 when viewed from the opposite side.

Referring to FIG. 9, the latch housing 110 may be provided with a groove into which one end of the elastic member 130 may be coupled. In addition, a groove, into which the other end of the elastic member 130 may be coupled, may be formed on one surface of the lever 140.

As the elastic member 130 is coupled to the latch housing 110 and the lever 140, the elastic member 130 may be compressed or decompressed by the rotation of the lever 140. In addition, a groove may be additionally formed along a path along which the other end of the elastic member 130 moves.

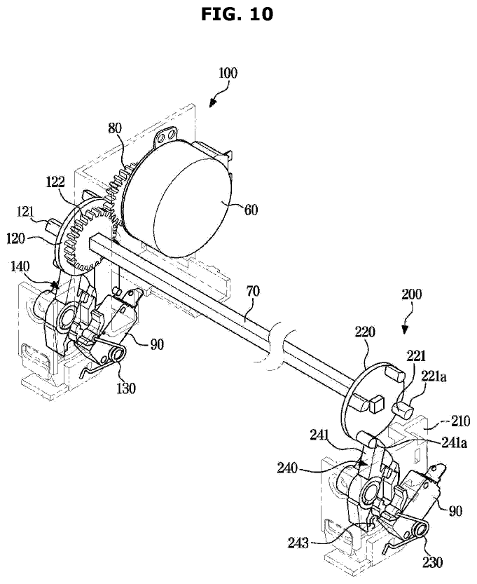

FIG. 10 is a perspective view illustrating a door latch of the cooking apparatus 1 according to one embodiment of the present disclosure.

A door latch device applicable to the cooking apparatus 1 according to one embodiment of the present disclosure may be provided with two door latches.

A door latch configured to receive power directly or through a power transmission portion 80 including at least one gear as the driving motor 60 is provided, may represent a first door latch 100, and a second door latch 200 configured to receive power from the first door latch 100 and assist in opening and closing the door 40 together with the first door latch 100 may be provided.

The components of the first door latch 100 may be described by adding the ordinal number “1” to each of the components of the door latch 100 described in FIGS. 1 to 9, such as the latch housing 110, the rotating body 120, the driving protrusion 121, the pressure protrusion 121a, the rotating gear 122, the elastic member 130, the lever 140, the lever arm 141, the lever

recess 141a, the lever groove 142, and the lever hook 143.

The second door latch 200 may include components that are substantially similar to those of the first door latch 100.

Particularly, the second door latch 200 may include a second rotating body 220, a second driving protrusion 221, and a second pressure protrusion 221a protruding from the second rotating body 220. The second rotating body 220 is configured to be rotated about a transmission shaft. In addition, in order to receive power from the first door latch 100, the second rotating body 220 may be connected to the first rotating body 120 through a link rod 70 having a substantially long bar shape provided between the second rotating body 220 and the first rotating body 120.

FIG. 10 illustrates that the link rod 70 is formed to include the transmission shaft, but the present disclosure is not necessarily limited thereto. Accordingly, it is sufficient that the first door latch 100 and the second door latch 200 are connected so as to transmit power transmitted from the driving motor 60.

The second door latch 200 may include a second latch housing 110 forming an exterior of the second door latch 200, and a second lever 240 including a second lever hook 243 coupled to the second latch housing to restrain or release the second key door 42. A second lever groove 242 may be formed between the second lever hook 243 and a portion of the second lever 240 to accommodate an end portion of the second key door 42.

The second lever 240 may include a second lever arm 241 extending from a rotation shaft of the second lever 240 so as to efficiently transmit power from the second driving protrusion 221. A second lever recess 241a may be formed at an end portion of the second lever arm 241 so as to guide at least a portion of the second driving protrusion 221.

Additionally, the second door latch 200 may include a second elastic member 230 configured to elastically press the second lever 240. One end of the second elastic member 230 may be coupled to the second latch housing 110, and the other end thereof may be coupled to the second lever 240.

An operation method of the second door latch 200 may be similar to the operation method of the first door latch 100 in which the direction, in which the first elastic member 130 presses the first lever 140, changes as the first door latch 100 passes through the critical position while being rotated between the first position and the second position.

In addition, the role of the second door latch 200 may be provided symmetrically with the first door latch 100 to prevent malfunction of the door 40.

Referring to FIG. 10, among the components of the first door latch 100 and the second door latch 200, the first rotating body 120 and the second rotating body 220 may be formed symmetrically. The other components may be formed identically and only the arrangement may be arranged at opposite ends based on the link rod 70.

When the first door latch 100 and the second door latch 200 are formed identically, an effect of reducing manufacturing costs may be expected.

The second door latch 200 may serve as an auxiliary function to the first door latch 100 to stably open and close the door 40. Accordingly, other components, excluding the second lever 240 provided to fix the second key door 42, may be omitted.

For example, the second door latch 200 may include only the second lever 240 and the second rotating body 220, or may include only the second lever 240, the second rotating body 220, and the second elastic member 230. However, the component of the second door latch 200 is not necessarily omitted from the first door latch 100. That is, the present disclosure is not limited thereto.

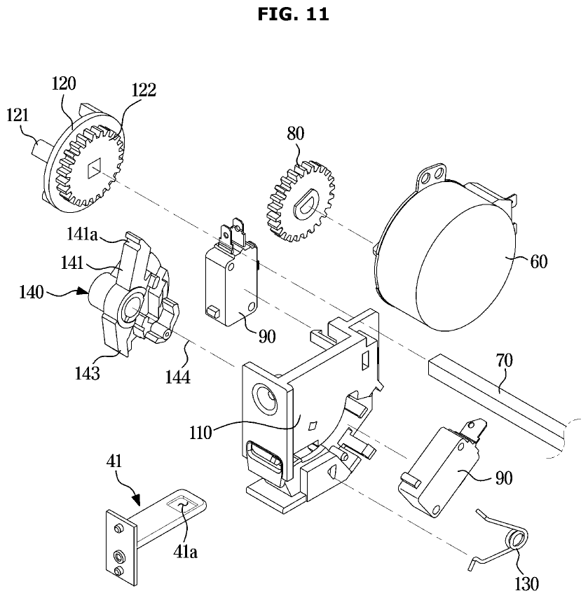

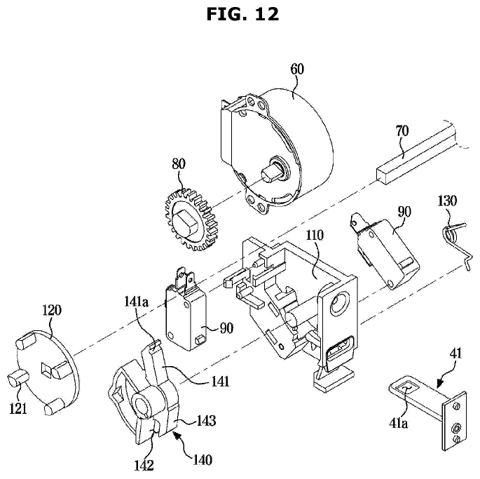

FIG. 11 is an exploded perspective view of a door latch according to one embodiment of the present disclosure, and FIG. 12 is an exploded perspective view of the door latch of FIG. 11 when viewed from another side.

FIGS. 11 and 12 are perspective views that conveniently illustrate the shapes and coupling relationships of the components, which are disassembled for easy viewing. Components that are described to be separable in FIGS. 11 and 12 may, in some cases, be manufactured as one piece and not separable.

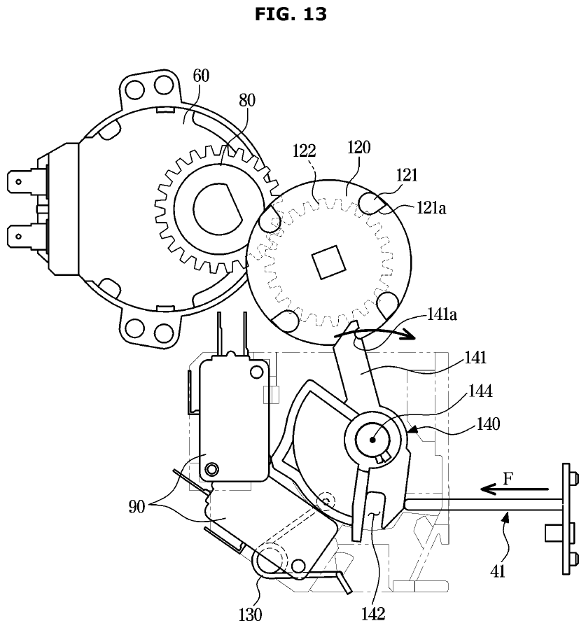

FIG. 13 is a view illustrating a state in which an external force is applied while opening the door 40 of the cooking apparatus 1 according to one embodiment of the present disclosure. In a state in which a plurality of driving protrusions is provided, when a user attempts to close the door 40 by applying an external force F while the door 40 is being opened, the lever may collide with the driving protrusion, causing interference.

In order to ease the difficulty, when a plurality of driving protrusions 121 is provided, a gap between the plurality of driving protrusions 121 may be designed so as not to interfere with the lever during the process of opening and closing the door 40. Particularly, an angle between the plurality of driving protrusions 121 based on the transmission shaft of the rotating body may be designed to be greater than or equal to an angle based on the lever rotation shaft 144 between the driving protrusion 121 in contact with the lever at the first position and the driving protrusion 121 in contact with the lever at the critical position.

A cooking apparatus 1 according to one embodiment of the present disclosure may include a housing 10 forming a cooking chamber 11, a door 40 configured to open and close the cooking chamber 11 and including a key door 41 protruding toward the housing 10, a driving motor 60 disposed within the housing 10, and a door latch 100 configured to lock or unlock the door 40. The door latch 100 may include a rotating body 120 configured to be rotated by power transmitted from the driving motor 60, a lever 140 configured to be rotated about a lever rotation shaft 144 by power transmitted from the rotating body 120, the lever configured to restrain or release the key door 41 according to a position of the lever 140, and an elastic member 130 configured to elastically press the lever 140 and configured to rotate the lever 140 in a direction in which the lever 140 locks or unlocks the door 40 according to the position of the lever 140.

The lever may be configured to be rotated between a first position P1 that restrains the key door 41 in response to the door 40 being closed and a second position P2 that releases the key door 41 to allow the

door 40 to be opened. The elastic member 130 may have a maximum elastic force at a critical position C between the first position P1 and the second position P2 of the lever 140.

The lever 140 may be elastically pressed in a locking direction of the door 40 by the elastic member 130 between the first position and the critical position C, and elastically pressed in an unlocking direction of the door 40 by the elastic member 130 between the second position P2 and the critical position C.

The lever 140 may include a lever arm 141 extending from the lever rotation shaft 144 and configured to receive power from the rotating body 120.

The key door 41 may include a key door hole 41a formed on an end portion of the key door 41. The lever 140 may further include a lever groove 142 provided to accommodate an end portion of the key door 41, and a lever hook 143 provided to be accommodated in the key door hole in response to the end portion of the key door 41 being accommodated in the lever groove 142.

While the door 40 is being opened, the lever 140 may be rotated past the critical position C to the second position P2 and be separated from the key door hole 41a. While the door 40 is being closed, the lever 140 may be rotated past the critical position C to the first position P1 and be accommodated in the key door hole 41a.

The door latch 100 may further include a driving protrusion 121 protruding from one surface of the rotating body 120.

The driving protrusion 121 may include a plurality of driving protrusions 121 arranged at intervals along a circumferential direction of the rotating body 120. An angle between a pair of adjacent driving protrusions 121 among the plurality of driving protrusions may be greater than or equal to an angle at which the driving protrusion 121 in contact with the lever 140 at the first position P1 is rotated to the critical position C. According to the present disclosure, when the plurality of driving protrusions 121 included in the rotating body 120 is appropriately arranged, the response speed of the door latch 100 after an opening signal of the door 40 is input may be improved, and even when a user forcibly closes the door 40 by applying an external force before the key door 41 is completely separated from the lever 140, the lever arm 141 may not interfere with the driving protrusion 121, thereby preventing a failure or malfunction.

The driving protrusion 121 may include a pressure protrusion 121a protruding toward a tangential direction of the rotating body 120. The lever arm 141 may be provided to accommodate at least a portion of the driving protrusion 121 and include a lever recess 141a.

The door latch 100 may include at least one micro switch to determine whether the door 40 is opened or closed.

The door latch 100 may further include a latch housing 110 to which the lever 140 is coupled. One end of the elastic member 130 may be fixed to the latch housing 110 and the other end thereof may be fixed to the lever 140.

The door latch 100 may be a first door latch 100, the rotating body 120 may be a first rotating body 120, the elastic member may be a first elastic member 130, the key door 41 may be a first key door 41, and the lever 140 may be a first lever 140. The door 40 may further include a second key door 42 protruding toward the housing 10. The housing 10 may further include a second door latch 200 configured to fix the door 40. The second door latch 200 may include a second rotating body 220 connected to the first rotating body 120 via a link rod 70, a second lever 240 configured to be rotated by power transmitted from the second rotating body 220, the lever configured to lock or unlock the door 40 according to a position of the second lever 240, and a second elastic member 230 configured to elastically press the second lever 240 according to rotation of the second lever 240 and configured to rotate the second lever 240 in a direction in which the second lever 240 locks or unlocks the door 40 according to the position of the second lever 240.

The lever groove 142 may be a first lever groove 142. The second key door 42 may include a second key door hole 42a formed on an end portion of the second key door 42. The second lever 240 may include a second lever arm 241 extending from the lever rotation shaft 144 and configured to receive power from the second rotating body 220, a second lever groove 242 provided to accommodate an end portion of the second key door 42, and a second lever hook 243 provided to be accommodated in the second key door hole 42a in response to the end portion of the second key door 42 being accommodated in the second lever groove 242.

A door latch device according to one embodiment of the present disclosure may be configured to lock or unlock a door 40 including a key door 41. The door latch device may include a driving motor 60, and a door latch 100 configured to lock or unlock the door 40. The door latch 100 may include a rotating body 120 configured to be rotated by power transmitted from the driving motor 60, a lever 140 configured to be rotated about a lever rotation shaft 144 by power transmitted from the rotating body 120, the lever configured to restrain or release the key door 41 according to a position of the lever 140, and an elastic member 130 configured to elastically press a latch housing 110, to which the lever 140 is coupled, and the lever and configured to rotate the lever 140 to a first position P1, in which the door 40 is locked, or a second position P2, in which the door 40 is unlocked, according to a position of the lever 140.

The elastic member 130 may have a maximum elastic force at a critical position C between the first position P1 and the second position P2 of the lever 140. The lever 140 may include a lever arm 141 extending from the lever rotation shaft 144 and configured to receive power from the rotating body 120.

The key door 41 may include a key door hole 41a formed on an end portion of the key door 41. The lever 140 may further include a lever groove 142 provided to accommodate an end portion of the key door 41, and a lever hook 143 provided to be accommodated in the key door hole in response to the end portion of the key door 41 being accommodated in the lever groove 142.

The door latch 100 may further include a plurality of driving protrusion 121 protruding from one surface of the rotating body 120 and configured to transmit power to the lever arm 141.

The door latch 100 may be a first door latch 100, the rotating body 120 may be a first rotating body 120, the elastic member may be a first elastic member 130, the key door 41 may be a first key door 41, and the lever 140 may be a first lever 140. The door 40 may further include a second key door 42 protruding toward the housing 10. The housing 10 may further include a second door latch 200 configured to fix the door 40. The second door latch 200 may include a second rotating body 220 connected to the first rotating body 120 via a link rod 70, a second lever 240 configured to be rotated by power transmitted from the second rotating body 220, the second lever 240 configured to lock or unlock the door 40 according to a position of the second lever 240, and a second elastic member 230 configured to elastically press the second lever 240 according to rotation of the second lever 240 and configured to rotate the second lever 240 in a direction in which the second lever 240 locks or unlocks the door 40 according to the position of the second lever 240.

While the present disclosure has been particularly described with reference to exemplary embodiments, it should be understood by those of skilled in the art that various changes in form and details may be made without departing from the spirit and scope of the present disclosure.

What is claimed is:

1. A cooking apparatus comprising:
a housing including a cooking chamber;
a door configured to open or close the cooking chamber, the door comprising a key door;
a driving motor disposed in the housing; and
a door latch configured to lock or unlock the door, wherein the door latch comprises:
a rotating body configured to be rotated by power transmitted from the driving motor;
a lever rotation shaft;
a lever configured to be rotated about the lever rotation shaft by power transmitted from the rotating body, the lever configured to restrain the key door to lock the door or release the key door to unlock the door according to a position of the lever; and
an elastic member configured to elastically press the lever and configured to rotate the lever in a direction in which the lever locks or unlocks the door by engaging with the key door according to the position of the lever.

2. The cooking apparatus of claim 1, wherein
the lever is configured to be rotated between a first position that restrains the key door in response to the door being closed and a second position that releases the key door to allow the door to be opened,
wherein the elastic member has a maximum elastic force at a critical position of the lever between the first position and the second position of the lever.

3. The cooking apparatus of claim 2, wherein
the lever is elastically pressed in a locking direction of the door by the elastic member between the first position and the critical position, and the lever is elastically pressed in an unlocking direction of the door by the elastic member between the second position and the critical position.

4. The cooking apparatus of claim 2, wherein
the lever comprises a lever arm extending from the lever rotation shaft and configured to receive power from the rotating body.

5. The cooking apparatus of claim 4, wherein
the key door comprises a key door hole formed on an end portion of the key door,
wherein the lever further comprises:
a lever groove to accommodate an end portion of the key door; and
a lever hook to be accommodated in the key door hole in response to the end portion of the key door being accommodated in the lever groove.

6. The cooking apparatus of claim 5, wherein
while the door is being opened, the lever is configured to rotate past the critical position to the second position and is separated from the key door hole; and
while the door is being closed, the lever is configured to rotate past the critical position to the first position and is accommodated in the key door hole.

7. The cooking apparatus of claim 4, wherein
the door latch further comprises a driving protrusion protruding from one surface of the rotating body.

8. The cooking apparatus of claim 7, wherein
the driving protrusion comprises a plurality of driving protrusions arranged at intervals along a circumferential direction of the rotating body, and
wherein an angle between a pair of adjacent driving protrusions among the plurality of driving protrusions is greater than or equal to an angle at which the driving protrusion in contact with the lever at the first position is rotated to the critical position.

9. The cooking apparatus of claim 7, wherein
the driving protrusion comprises a pressure protrusion protruding toward a tangential direction of the rotating body,
wherein the lever arm includes a lever access to accommodate at least a portion of the driving protrusion therein.

10. The cooking apparatus of claim 7, wherein the door latch comprises a sensor to determine whether the door is opened or closed.

11. The cooking apparatus of claim 7, wherein
the door latch further comprises a latch housing to which the lever is coupled,
wherein one end of the elastic member is fixed to the latch housing and an other end of the elastic member is fixed to the lever.

12. The cooking apparatus of claim 5, wherein
the door latch is a first door latch, the rotating body is a first rotating body, the elastic member is a first elastic member, the key door is a first key door, and the lever is a first lever,
wherein the door further comprises a second key door,
wherein the housing further comprises a second door latch configured to lock or unlock the door,
wherein the second door latch comprises:
a second rotating body connected to the first rotating body via a link rod;
a second lever configured to be rotated by power transmitted from the second rotating body, the lever configured to restrain the second key door to lock the door or release the second key door to unlock the door according to a position of the second lever; and
a second elastic member configured to elastically press the second lever according to a rotation of the second lever, the second elastic member configured to rotate the second lever in a direction in which the second lever locks or unlocks the door by engaging with the second key door according to the position of the second lever.

13. The cooking apparatus of claim 12, wherein
the lever groove is a first lever groove,
wherein the second key door comprises a second key door hole formed on an end portion of the second key door,
wherein the second lever comprises:
a second lever arm extending from the lever rotation shaft and configured to receive power from the second rotating body;
a second lever groove to accommodate an end portion of the second key door; and
a second lever hook to be accommodated in the second key door hole in response to the end portion of the second key door being accommodated in the second lever groove.
